(19) United States
(12) Patent Application Publication
(10) Pub. No.: US 2013/0249881 A1
(43) Pub. Date: Sep. 26, 2013

(54) DISPLAY DEVICE, APPARATUS FOR GENERATING GAMMA VOLTAGE, AND METHOD FOR THE SAME

(71) Applicants: Se-Byung CHAE, Yongin-City (KR); Wook LEE, Yongin-City (KR)

(72) Inventors: Se-Byung CHAE, Yongin-City (KR); Wook LEE, Yongin-City (KR)

(21) Appl. No.: 13/669,845

(22) Filed: Nov. 6, 2012

(30) Foreign Application Priority Data
Mar. 26, 2012 (KR) 10-2012-0030685
Aug. 20, 2012 (KR) 10-2012-0090755

(51) Int. Cl. G09G 5/00

(52) U.S. Cl. 345/211

(57) ABSTRACT

A display device includes a display unit including a plurality of pixels connected to a plurality of data lines, a data driver selecting a grayscale voltage according to an image data signal among a plurality of gamma voltages to apply the grayscale voltage to the plurality of data lines, a gamma voltage generator generating a plurality of gamma voltages; and a reference voltage generator generating a reference voltage to generate a plurality of gamma voltages in cooperation with a power source voltage to drive the plurality of pixels.

### CROSS-REFERENCE TO RELATED APPLICATION

This application claims priority to and the benefit of Korean Patent Application No. 10-2012-0030685, filed in the Korean Intellectual Property Office on Mar. 26, 2012, and Korean Patent Application No. 10-2012-0090755, filed in the Korean Intellectual Property Office on Aug. 20, 2012, the entire contents of which are incorporated herein by reference.

### BACKGROUND

1. Field

Example embodiments relate to a display device, a gamma voltage generating apparatus, and a gamma voltage generating method. More particularly, the example embodiments relate to a display device, a gamma voltage generating apparatus, and a gamma voltage generating method to equally maintain a luminance in a process of predetermining a gamma voltage and a luminance after producing a product.

2. Description of the Related Art

In a production process of a display device, a process of predetermining a gamma voltage is essential to improve image quality of the display device. The process of predetermining the gamma voltage is a process of predetermining the gamma voltage for each grayscale such that the luminance according to each grayscale becomes a 2.2 gamma curve. In general, the 2.2 gamma curve has luminescence characteristics that are optimally recognized by eyes of a person.

In the process of predetermining the gamma voltage, a test apparatus is connected to the display panel. Further, an ELVDD voltage is supplied to the display panel through a DC/DC converter of the test apparatus, and the gamma voltage is one for the entire grayscale for the luminance according to each grayscale to be the 2.2 gamma curve.

In a completed product state after the production process of the display device, the ELVDD voltage is supplied to the display panel through the DC/DC converter provided in the display device.

However, a deviation may be generated between the output of the DC/DC converter used in the process of predetermining the gamma voltage and the output of the DC/DC converter provided in the display device. Also, resistance of a connector used to connect the display panel in the process of predetermining the gamma voltage and test apparatus and resistance of a connector actually used in the display device may be different from each other. Accordingly, a deviation may be generated between the ELVDD voltage supplied to the display panel in the process of predetermining the gamma voltage and the ELVDD voltage supplied to the display panel in the display device.

That is, the luminance after producing the product is not equally maintained with the luminance in the process of predetermining the gamma voltage. This causes deterioration of an image quality characteristic of the display device.

The above information disclosed in this Background section is only for enhancement of understanding of the background of the invention and therefore it may contain information that does not form the prior art that is already known in this country to a person of ordinary skill in the art.

### SUMMARY

The example embodiments provide a display device, a gamma voltage generating apparatus, and a gamma voltage generating method to equally maintain a luminance in a process of predetermining a gamma voltage and a luminance after producing a product.

A display device according to an exemplary embodiment includes a display unit having a plurality of pixels connected to a plurality of data lines; a data driver selecting a grayscale voltage according to an image data signal among a plurality of gamma voltages to apply the grayscale voltage to the plurality of data lines; a gamma voltage generator generating a plurality of gamma voltages; and a first reference voltage generator generating a reference voltage to generate a plurality of gamma voltages in cooperation with a power source voltage to drive the plurality of pixels.

The first reference voltage generator may register a voltage difference between a first power source voltage and a first reference voltage in the process of predetermining the gamma voltage, and may generate a second reference voltage as a differential value between a second power source voltage and the registered voltage difference.

The first reference voltage generator may include: a voltage difference generator including a plurality of resistors coupled in series between a reference voltage and a ground voltage; a voltage difference selection unit selecting and outputting a voltage corresponding to a voltage difference between the first power source voltage and the first reference voltage among a plurality of distribution voltages distributed to a plurality of resistors; and a reference voltage output unit outputting a differential value between the second power source voltage and the voltage output from the voltage difference selection unit as the second reference voltage.

A plurality of resistors included in the voltage difference generator may have a resistance determined for a plurality of distribution voltages to be distributed as a predetermined unit.

The voltage difference selection unit may register a voltage difference between the first power source voltage and the first reference voltage in the process of predetermining the gamma voltage and may output the registered voltage difference to the reference voltage output unit after producing a product.

The reference voltage output unit may include a differential amplifier outputting a differential value between a power source voltage supplied from the outside and the voltage output from the voltage difference selection unit.

The gamma voltage generator may include a reference voltage division unit including: a plurality of resistors coupled in series between the reference voltage and a base voltage; a gamma voltage selection unit selecting a plurality of gamma voltages corresponding to a predetermined grayscale by using a plurality of distribution voltages distributed to a plurality of resistors; and a gamma voltage output unit outputting a plurality of gamma voltages corresponding to an entire grayscale by using the reference voltage provided from the reference voltage generator and a plurality of gamma voltages selected from the gamma voltage selection unit.

The gamma voltage selection unit may include a first selector selecting a second gamma voltage representing a gray level higher than the first gamma voltage corresponding to the reference voltage by one.

The gamma voltage selection unit may further include a second selector selecting a seventh gamma voltage as a lowest voltage among a plurality of gamma voltages corresponding to the entire grayscale.

The gamma voltage selection unit may further includes a sixth selector selecting a sixth gamma voltage by using a distribution resistor connected to the second gamma voltage transmitted from the first selector and the seventh gamma voltage selected from the second selector.

The gamma voltage selection unit may further include a fifth selector selecting a fifth gamma voltage by using a distribution resistor connected to the second gamma voltage transmitted from the first selector and the sixth gamma voltage selected from the six selector.

The gamma voltage selection unit may further include a fourth selector selecting a fourth gamma voltage by using a distribution resistor connected to the second gamma voltage transmitted from the first selector and the fifth gamma voltage selected from the fifth selector.

The gamma voltage selection unit may further include a third selector selecting a third gamma voltage by using a distribution resistor connected to the second gamma voltage transmitted from the first selector and the fourth gamma voltage selected from the fourth selector.

The gamma voltage generator may further include a micro-controller providing a register value for minute control of the gamma voltage to the gamma voltage selection unit.

A second reference voltage generator generating a base voltage to generate a plurality of gamma voltages in cooperation with a power source voltage to drive a plurality of pixels may be further included.

The second reference voltage generator may register a voltage difference between a first power source voltage and a first base voltage in the process of predetermining the gamma voltage, and may generate a second base voltage as a differential value between a second power source voltage and the registered voltage difference.

The second reference voltage generator may include: a first differential amplifier including a first input terminal input with the reference voltage and an output terminal outputting the amplifying voltage; a voltage difference generator including a plurality of resistors coupled in series between the amplifying voltage and a ground; a voltage difference selection unit selecting a distribution voltage from the voltage difference generator to output an amplifying voltage corresponding to a voltage difference between the first power source voltage and the first base voltage from the first differential amplifier and to input the distribution voltage to the second input terminal of the first differential amplifier; and a base voltage output unit outputting a differential value of the second power source voltage and the amplifying voltage as a second base voltage.

The voltage difference selection unit may register the amplifying voltage corresponding to the voltage difference between the first power source voltage and the first base voltage in a process of generating the gamma voltage, and the registered amplifying voltage may be output through the first differential amplifier after producing the product.

The base voltage output unit may include a second differential amplifier that outputs a differential value of a power source voltage supplied from the outside and an amplifying voltage output from the first differential amplifier.

A gamma voltage generating apparatus according to another exemplary embodiment includes a first reference voltage generator registering a voltage difference between a first power source voltage to drive a plurality of pixels and a predetermined first reference voltage in a process of predetermining a gamma voltage, and generating a second reference voltage as a differential value between a second power source voltage to drive a plurality of pixels and the registered voltage difference; and a gamma voltage generator generating a plurality of gamma voltages by using the second reference voltage.

The first reference voltage generator may include: a voltage difference generator including a plurality of resistors coupled in series between a reference voltage and a ground voltage; a voltage difference selection unit selecting and outputting a voltage corresponding to a voltage difference between the first power source voltage and the first reference voltage among a plurality of distribution voltages distributed to a plurality of resistors; and a reference voltage output unit outputting a differential value between the second power source voltage and the voltage output from the voltage difference selection unit as the second reference voltage.

A plurality of resistors included in the voltage difference generator may have resistances determined for a plurality of distribution voltages to be distributed as a predetermined unit.

The voltage difference selection unit may register a voltage difference between the first power source voltage and the first reference voltage in the process of predetermining the gamma voltage, and outputs the registered voltage difference to the reference voltage output unit after producing a product.

The reference voltage output unit may include a differential amplifier outputting a differential value between the second power source voltage and the voltage output from the voltage difference selection unit.

The gamma voltage generator may include a reference voltage division unit including a plurality of resistors coupled in series between the second reference voltage and a base voltage; a gamma voltage selection unit selecting a plurality of gamma voltages corresponding to a predetermined grayscale by using a plurality of distribution voltages distributed to a plurality of resistors; and a gamma voltage output unit outputting a plurality of gamma voltages corresponding to an entire grayscale by using the second reference voltage and a plurality of gamma voltages selected from the gamma voltage selection unit.

The gamma voltage selection unit may include a first selector selecting the second gamma voltage representing a gray level higher than the first gamma voltage corresponding to the second reference voltage by one.

The gamma voltage selection unit may further include a second selector selecting a seventh gamma voltage as a lowest voltage among a plurality of gamma voltages corresponding to the entire grayscale.

The gamma voltage selection unit may further include a sixth selector selecting a sixth gamma voltage by using a distribution resistor connected to the second gamma voltage transmitted from the first selector and the seventh gamma voltage selected from the second selector.

The gamma voltage selection unit may further include a fifth selector selecting a fifth gamma voltage by using a distribution resistor connected to the second gamma voltage transmitted from the first selector and the sixth gamma voltage selected from the six selector.

The gamma voltage selection unit may further include a fourth selector selecting a fourth gamma voltage by using a distribution resistor connected to the second gamma voltage transmitted from the first selector and the fifth gamma voltage selected from the fifth selector.

The gamma voltage selection unit may further include a third selector selecting a third gamma voltage by using a distribution resistor connected to the second gamma voltage transmitted from the first selector and the fourth gamma voltage selected from the fourth selector.

A second reference voltage generator generating a base voltage to generate a plurality of gamma voltages in cooperation with a power source voltage to drive a plurality of pixels may be further included.

The second reference voltage generator may register a voltage difference between a first power source voltage and a first base voltage in the process of predetermining the gamma voltage, and may generate a second base voltage as a differential value between a second power source voltage and the registered voltage difference.

The second reference voltage generator may include: a first differential amplifier including a first input terminal input with the reference voltage and an output terminal outputting the amplifying voltage; a voltage difference generator including a plurality of resistors coupled in series between the amplifying voltage and a ground; a voltage difference selection unit selecting a distribution voltage from the voltage difference generator to output an amplifying voltage corresponding to a voltage difference between the first power source voltage and the first base voltage from the first differential amplifier and to input the distribution voltage to the second input terminal of the first differential amplifier; and a base voltage output unit outputting a differential value of the second power source voltage and the amplifying voltage as a second base voltage.

The voltage difference selection unit may register the amplifying voltage corresponding to the voltage difference between the first power source voltage and the first base voltage in a process of generating the gamma voltage, and the registered amplifying voltage may be output through the first differential amplifier after producing the product.

The base voltage output unit may include a second differential amplifier that outputs a differential value of a power source voltage supplied from the outside and an amplifying voltage output from the first differential amplifier.

A gamma voltage generating method according to another exemplary embodiment includes registering a voltage difference between a first power source voltage to drive a plurality of pixels and a predetermined first reference voltage in the process of predetermining the gamma voltage; generating a second reference voltage as a differential value between a second power source voltage to drive a plurality of pixels and the registered voltage difference after producing a product; and generating a plurality of gamma voltages by using the second reference voltage.

The registering of the voltage difference may include selecting a voltage corresponding to a voltage difference between the first power source voltage and the first reference voltage among a plurality of distribution voltages distributed to a plurality of resistors coupled in series between the reference voltage and the ground voltage.

The method may further include registering a second voltage difference of the first power source voltage to drive a plurality of pixels and a predetermined first base voltage in the process of predetermining the gamma voltage.

The method may further include generating a second base voltage as a differential value of the second power source voltage to drive a plurality of pixels after producing a product and the registered second voltage difference after producing a product.

The generating of a plurality of gamma voltages may include generating a plurality of gamma voltages by using the second reference voltage and the second base voltage.

The generating of a plurality of gamma voltages may include: selecting a plurality of gamma voltages corresponding to a predetermined grayscale by using a plurality of distribution voltages distributed to a plurality of resistors coupled in series between the second reference voltage and the ground voltage; and generating a plurality of gamma voltages corresponding to an entire grayscale by using the second reference voltage and a plurality of gamma voltages corresponding to the predetermined grayscale.

The selecting of a plurality of gamma voltages corresponding to a predetermined grayscale may include selecting the second gamma voltage representing a gray level higher than the first gamma voltage corresponding to the second reference voltage.

The selecting of a plurality of gamma voltages corresponding to a predetermined grayscale may include selecting a seventh gamma voltage as a lowest voltage among a plurality of gamma voltages corresponding to the entire grayscale

The selecting of a plurality of gamma voltages corresponding to a predetermined grayscale may include selecting a sixth gamma voltage by using a distribution resistor connected to the second gamma voltage and the seventh gamma voltage.

The selecting of a plurality of gamma voltages corresponding to a predetermined grayscale may include selecting a fifth gamma voltage by using a distribution resistor connected between the second gamma voltage and the sixth gamma voltage.

The selecting of a plurality of gamma voltages corresponding to a predetermined grayscale may include selecting a fourth gamma voltage by using a distribution resistor connected between the second gamma voltage and the fifth gamma voltage.

The selecting of a plurality of gamma voltages corresponding to a predetermined grayscale may include selecting a third gamma voltage by using a distribution resistor connected between the second gamma voltage and the fourth gamma voltage.

The luminance in the process of predetermining the gamma voltage and the luminance after the product production are equally maintained, and the image quality characteristic of the display device may be improved.

### BRIEF DESCRIPTION OF THE DRAWINGS

FIG. 1 is a block diagram of a display device according to an exemplary embodiment.

FIG. 2 is a circuit diagram of a pixel according an exemplary embodiment.

FIG. 3 is a block diagram of a gamma voltage generator according to an exemplary embodiment.

FIG. 4 is a block diagram of a first reference voltage generator according to an exemplary embodiment.

FIG. 5 is an exemplary view showing a relation between an ELVDD voltage and a reference voltage in a process of predetermining a gamma voltage according to an exemplary embodiment and after producing a product.

FIG. 6 is an exemplary view showing a relation between an ELVDD voltage and a reference voltage of a gamma voltage in a process of predetermining a gamma voltage in a conventional process of predetermining a gamma voltage and after producing a product.

FIG. 7 is a block diagram of a second reference voltage generator according to an exemplary embodiment.

FIG. 8 is an exemplary view showing a relation between an ELVDD voltage and a base voltage in a process of predetermining a gamma voltage and after producing a product according to an exemplary embodiment.

FIG. 9 is an exemplary view showing a relation between an ELVDD voltage and a base voltage of a gamma voltage in a conventional process of predetermining a gamma voltage and after producing a product.

### DETAILED DESCRIPTION

Embodiments will be described more fully hereinafter with reference to the accompanying drawings, in which exemplary embodiments of the invention are shown. As those skilled in the art would realize, the described embodiments may be modified in various different ways, all without departing from the spirit or scope of the inventive concept.

Further, in several exemplary embodiments, constituent elements having the same construction are assigned the same reference numerals and are representatively described in connection with a first exemplary embodiment. In the remaining exemplary embodiments, only different constituent elements from those of the first exemplary embodiment are described.

To clarify the description of the example embodiments, parts not related to the description are omitted, and the same reference numbers will be used throughout the drawings to refer to the same or like parts.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

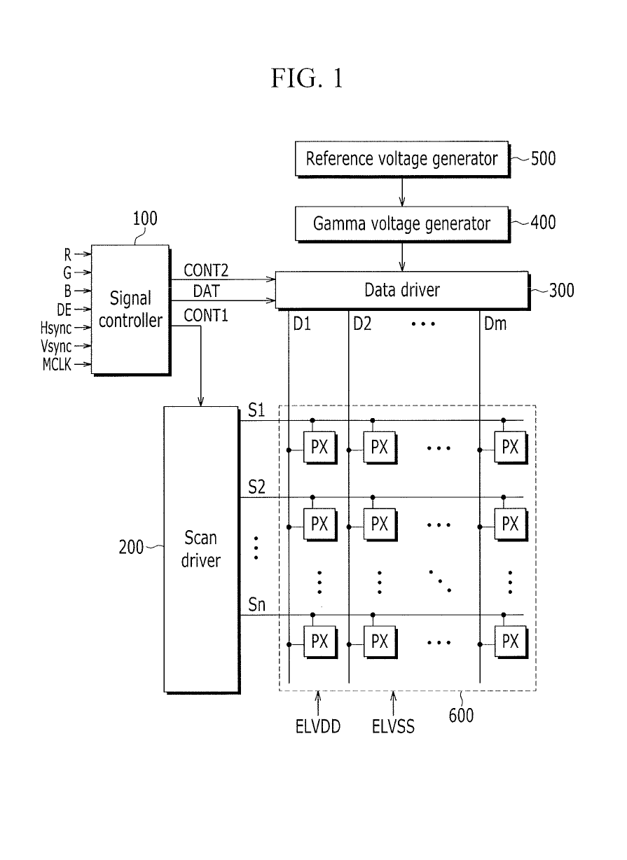

FIG. 1 is a block diagram of a display device according to an exemplary embodiment. Referring to FIG. 1, a display device includes a signal controller 100, a scan driver 200, a data driver 300, a gamma voltage generator 400, a reference voltage generator 500, and a display unit 600.

The signal controller 100 receives video signals R, G, and B that are inputted from an external device, and input control signals that control displaying thereof. The video signals R, G, and B include luminance information of each pixel PX, and the luminance has a grayscale having a predetermined number, for example 1024=2¹⁰, 256=2⁸, or 64=2⁶. For example, the input control signals may include a vertical synchronization signal Vsync, a horizontal synchronization signal Hsync, a main clock signal MCLK, and a data enable signal DE.

The signal controller 100 appropriately processes the input video signals R, G, and B for operation conditions of the display unit 600 and the data driver 300 based on the input video signals R, G, and B and the input control signals, and generates a scan control signal CONT1, a data control signal CONT2, and an image data signal DAT. The signal controller 100 transmits the scan control signal CONT1 to the scan driver 200. The signal controller 100 transmits the data control signal CONT2 and image data signal DAT to the data driver 300.

The display unit 600 includes a plurality of scan lines S1-Sn, a plurality of data lines D1-Dm, and a plurality of pixels PX. The plurality of pixels PX are connected to a plurality of signal lines S1-Sn and D1-Dm and are arranged in an approximate matrix. A plurality of scan lines S1-Sn extend in an approximate row direction and are almost parallel to each other. A plurality of data lines D1-Dm extend in an approximate column direction and are almost parallel to each other. The plurality of pixels PX of the display unit 600 are supplied with an ELVDD voltage and an ELVSS voltage from the outside.

The scan driver 200 is connected to the plurality of scan lines S1-Sn, and applies scan signals that include a combination of a gate-on voltage Von that turns on an application of a data signal for the pixels PX and a gate-off voltage Voff that turns it off to the plurality of scan lines S1-Sn according to the scan control signal CONT1.

The scan control signal CONT1 includes a scan start signal SSP and a clock signal CLK. The scan start signal SSP is a signal generating the first scan signal for displaying an image of one frame. The clock signal CLK is a synchronization signal for sequential application of the scan signals to the plurality of scan lines S1-Sn.

The data driver 300 is connected to the plurality of data lines D1-Dm and selects a grayscale voltage according to the image data signal DAT. The data driver 300 selects the grayscale voltage according to the image data signal DAT among a plurality of gamma voltages provided in the gamma voltage generator 400. The data driver 300 applies the grayscale voltage selected according to the data control signal CONT2 as the data signal to the plurality of data lines D1-Dm.

The gamma voltage generator 400 generates a plurality of gamma voltages for a plurality of grayscales and provides them to the data driver 300. A plurality of gamma voltages for a plurality of grayscales are used as the grayscale voltage. The gamma voltage generator 400 receives a reference voltage VREG and a base voltage VGS from the reference voltage generator 500 and divides between the reference voltage VREG and the base voltage to generate the plurality of gamma voltages. The reference voltage VREG as a voltage to generate a plurality of gamma voltages may be a voltage having a highest voltage value among the plurality of gamma voltages.

The reference voltage generator 500 generates and provides the reference voltage VREG to the gamma voltage generator 400. The reference voltage generator 500 compares the reference voltage VREG to a power source voltage supplied from the outside such that the voltage difference between the power source voltage and the reference voltage VREG is the same in the process of predetermining the gamma voltage and after producing the product. The power source voltage includes a first power source voltage ELVDD′ to drive a plurality of pixels PX in the process of predetermining the gamma voltage and a second power source voltage ELVDD to drive a plurality of pixels PX after producing the product.

For this, the reference voltage generator 500 registers a voltage difference ΔV between the first power source voltage ELVDD′ supplied to the process of predetermining the gamma voltage and a reference voltage VREG′. Also, the reference voltage generator 500 generates a reference voltage VREG as a differential value of the second power source voltage ELVDD supplied after producing the product and the voltage difference ΔV.

The first power source voltage ELVDD′ supplied in the process of predetermining the gamma voltage and the second power source voltage ELVDD supplied after producing the product may be changed according to an output deviation of the DC/DC converter, which is a resistance deviation of a connector. However, the voltage difference ΔV between the power source voltage and the reference voltage in the process of predetermining the gamma voltage and after producing the product may be equally determined.

Also, the reference voltage generator 500 generates the base voltage VGS and provides it to the gamma voltage generator 400. The reference voltage generator 500 co-operates the base voltage VGS to the power source voltage supplied from the outside such that the voltage difference between the power source voltage and the base voltage VGS is the same in the process of predetermining the gamma voltage and after producing the product.

For this, the reference voltage generator 500 registers the voltage difference ΔVg between the first power source voltage ELVDD′ supplied in the process of predetermining the gamma voltage and the base voltage VGS′. Also, the reference voltage generator 500 generates the base voltage VGS as a differential value of the second power source voltage ELVDD supplied after producing the product and the voltage difference ΔVg.

Accordingly, the voltage difference ΔVg between the power source voltage and the reference voltage in the process of predetermining the gamma voltage and after producing the product may be equally determined.

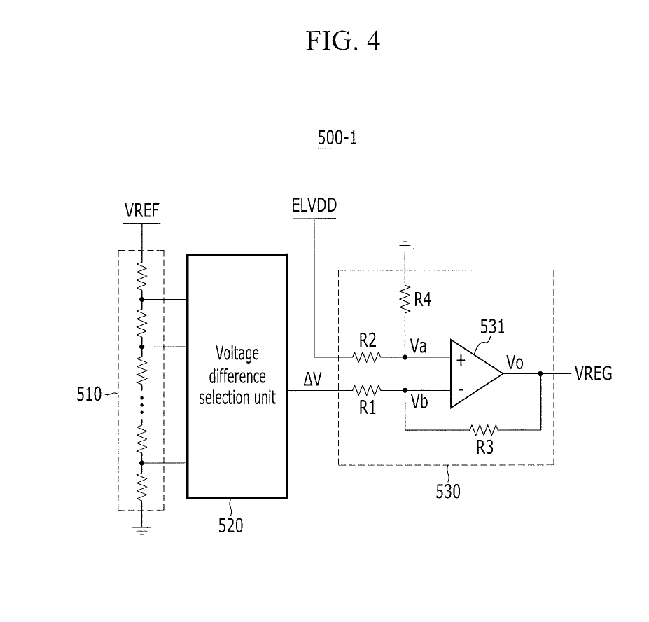

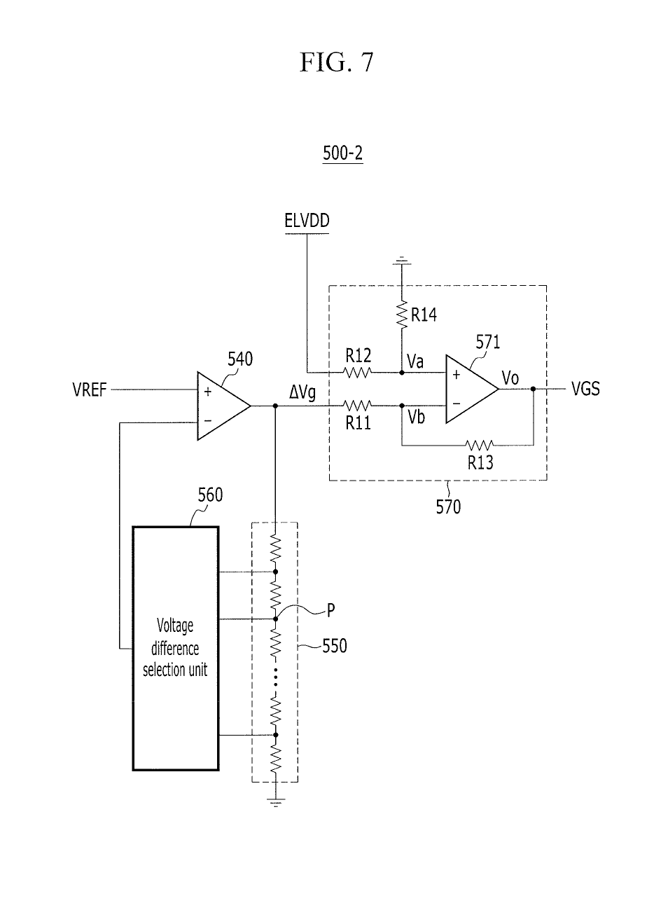

The reference voltage generator 500 includes a first reference voltage generator generating the reference voltage VREG to provide it to the gamma voltage generator 400, and a second reference voltage generator generating a base voltage VGS to provide it to the gamma voltage generator 400. The constitution of the first reference voltage generator and the second reference voltage generator will be described in FIG. 4 and FIG. 7 later.

Each driving device 100, 200, 300, 400, and 500 may be directly mounted outside the pixel area in the form of at least one integrated circuit chip, mounted on a flexible printed circuit film, attached to the display unit 600 in the form of a tape carrier package (TCP), or mounted on a separate printed circuit board (PCB). Alternatively, they may be integrated in the display unit 600 together with the signal lines S1-Sn and D1-Dm.

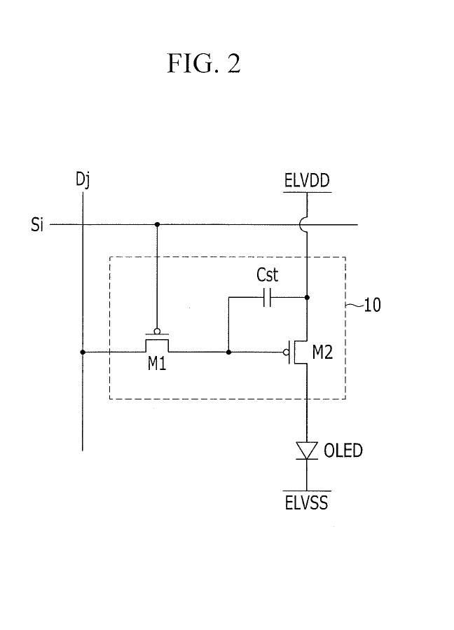

FIG. 2 is a circuit diagram of a pixel according an exemplary embodiment.

Referring to FIG. 2, a pixel PX of an organic light emitting diode (OLED) display includes an organic light emitting diode OLED and a pixel circuit 10 to control the organic light emitting diode OLED. The pixel circuit 10 includes a switching transistor M1, a driving transistor M2, and a sustain capacitor Cst.

Here, the pixel circuit 10 includes two transistors and one capacitor, however the pixel circuit of the organic light emitting diode (OLED) display may be variously constituted to be operated, and the display device according to the example embodiments are not limited to the constitution of the pixel circuit.

The switching transistor M1 includes a gate electrode connected to the scan line Si, one terminal connected to the data line Dj, and the other terminal connected to a gate electrode of the driving transistor M2.

The driving transistor M2 includes the gate electrode connected to the other terminal of the switching transistor M1, one terminal connected to an ELVDD voltage, and the other terminal connected to an anode of the organic light emitting diode (OLED).

The sustain capacitor Cst includes one terminal connected to the gate electrode of the driving transistor M2 and the other terminal connected to one terminal of the driving transistor M2. The sustain capacitor Cst charges the data voltage applied to the gate electrode of the driving transistor M2 and maintains the data voltage after the switching transistor M1 is turned off.

The organic light emitting diode (OLED) includes the anode connected to the other terminal of the driving transistor M2 and a cathode connected to an ELVSS voltage.

The switching transistor M1 and the driving transistor M2 may be a p-channel field effect transistor. Here, the gate-on voltage turning on the switching transistor M1 and the driving transistor M2 is a logic low level voltage, and the gate-off voltage turning them off is a logic high level voltage.

The switching transistor M1 and the driving transistor M2 are p-channel field effect transistors, however at least one of the switching transistor M1 and the driving transistor M2 may be an n-channel field effect transistor, and the gate-on voltage for turning on the n-channel electric field effect transistor is the logic high voltage, while the gate-off voltage for turning it off is the logic low voltage.

If the gate-on voltage Von is applied to the scan line Si, the switching transistor M1 is turned on and the data signal that is applied to the data line Dj is applied to an end of the sustain capacitor Cst through the turned on switching transistor M1 to charge the sustain capacitor Cst. The driving transistor M2 controls the current amount that flows from the ELVDD power source to the organic light emitting diode (OLED) by corresponding to the voltage value that is charged in the sustain capacitor Cst. That is, the driving transistor M2 controls the current amount flowing to the organic light emitting diode (OLED) corresponding to a difference between the ELVDD voltage and the gate voltage applied to the gate electrode.

The organic light emitting diode (OLED) emits light that corresponds to the current amount that flows through the driving transistor M2. The organic light emitting diode (OLED) can emit one color of light of primary colors. As examples of the primary colors, there may be three primary colors of red, green, and blue, and a desired color is displayed by a spatial or temporal sum of these three primary colors. In this case, a portion of the organic light emitting diodes (OLED) can emit white light, and if this is performed, the luminance is increased. Unlike this, organic light emitting diodes (OLED) of all the pixels PX can emit white light, and a portion of the pixels PX may further include a color filter (not shown) that converts the white light that is emitted from the organic light emitting diode (OLED) into any one of the primary colors.

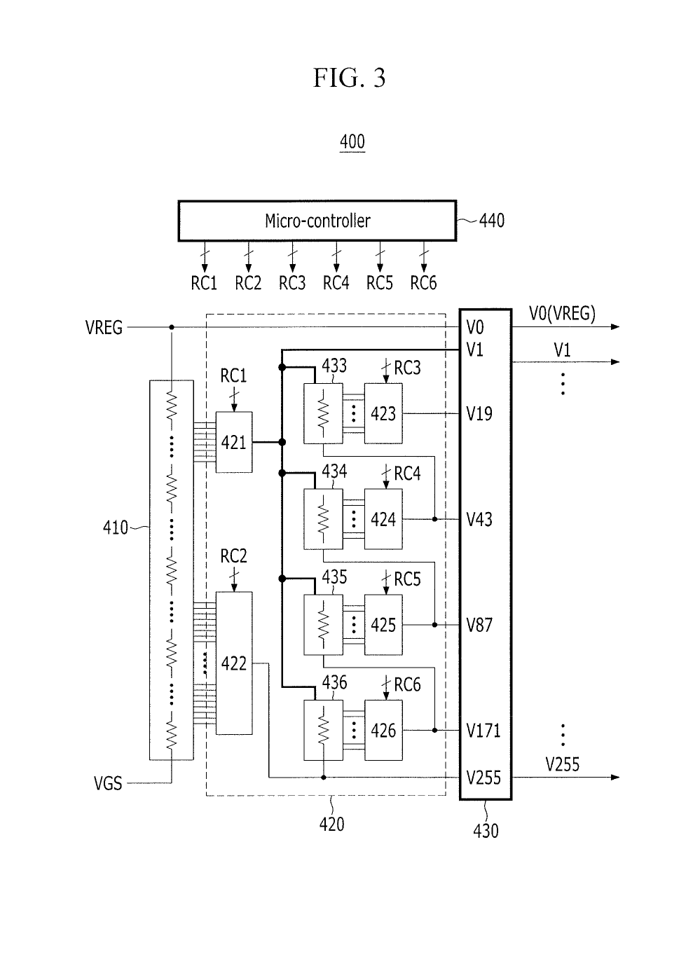

FIG. 3 is a block diagram of a gamma voltage generator according to an exemplary embodiment. Referring to FIG. 3, the gamma voltage generator 400 includes a reference voltage division unit 410, a gamma voltage selection unit 420, a gamma voltage output unit 430, and a micro-controller 440.

The reference voltage division unit 410 includes a plurality of resistors coupled in series between the reference voltage VREG and the base voltage VGS. The reference voltage division unit 410 outputs a plurality of distribution voltages divided to a plurality of resistors based on the reference voltage VREG and the base voltage VGS into the gamma voltage selection unit 420.

At this time, the reference voltage VREG is transmitted to the gamma voltage output unit 430, and the reference voltage VREG becomes the first gamma voltage V0 of the highest voltage among a plurality of gamma voltages. When the driving transistor M2 of the pixel is a p-channel field effect transistor, the first gamma voltage V0 is a voltage for the organic light emitting diode (OLED) emit with the lowest grayscale. When the driving transistor M2 of the pixel is an n-channel field effect transistor, the first gamma voltage V0 is a voltage for the organic light emitting diode (OLED) to emit with the highest grayscale.

The micro-controller 440 provides register values RC1 to RC6 for minute control of the gamma voltage to the gamma voltage selection unit 420.

The gamma voltage selection unit 420 includes a plurality of selectors 421 to 426 selecting the gamma voltage corresponding to a predetermined grayscale by using a plurality of distribution voltages.

The first selector 421 selects the second gamma voltage V1 among a plurality of distribution voltages according to the first register value RC1 provided from the micro-controller 440. The second gamma voltage V1 is a voltage representing the next lowest gray level and is lower than that of the first gamma voltage V0 by one. The first selector 421 transmits the second gamma voltage V1 to the gamma voltage output unit 430, the third selector 423, the fourth selector 424, the fifth selector 425, and the sixth selector 426.

The second selector 422 selects the seventh gamma voltage V255 among a plurality of distribution voltages according to the second register value RC2 provided from the micro-controller 440 and transmits it to the gamma voltage output unit 430. The seventh gamma voltage V255 as the gamma voltage having the lowest voltage among a plurality of gamma voltages may be a voltage representing the highest grayscale in the entire grayscale.

For example, when the driving transistor M2 of the pixel is the p-channel field effect transistor, the seventh gamma voltage V255 is the voltage light-emitting the organic light emitting diode (OLED) with the highest grayscale.

Meanwhile, when the driving transistor M2 of the pixel is the n-channel field effect transistor, the seventh gamma voltage V255 may be the voltage light-emitting the organic light emitting diode (OLED) with the lowest grayscale.

The third selector 423 selects the third gamma voltage V19 according to the third register value RC3 provided from the micro-controller 440 and transmits it to the gamma voltage output unit 430. The third selector 423 may select the third gamma voltage V19 by using a distribution resistor 433 connected to the second gamma voltage V1 transmitted from the first selector 421 and the fourth gamma voltage V43 selected from the fourth selector 424.

The fourth selector 424 selects the fourth gamma voltage V43 according to the fourth register value RC4 provided from micro-controller 440 and transmits it to the gamma voltage output unit 430. The fourth selector 424 may select the fourth gamma voltage V43 by using a distribution resistor 434 connected between the second gamma voltage V1 transmitted from the first selector 421 and the fifth gamma voltage V87 selected from the fifth selector 425.

The fifth selector 425 selects the fifth gamma voltage V87 according to the fifth register value RC5 provided from the micro-controller 440 and transmits it to the gamma voltage output unit 430. The fifth selector 425 may select the fifth gamma voltage V87 by using a distribution resistor 435 connected between the second gamma voltage V1 transmitted from the first selector 421 and the sixth gamma voltage V171 selected from the sixth selector 426.

The sixth selector 426 selects the sixth gamma voltage V171 according to the sixth register value RC6 provided from the micro-controller 440 and transmits it to the gamma voltage output unit 430. The sixth selector 426 may select the sixth gamma voltage V171 by using a distribution resistor 436 connected between the second gamma voltage V1 transmitted from the first selector 421 and the seventh gamma voltage V255 selected from the second selector 422.

The gamma voltage output unit 430 outputs a plurality of gamma voltages V0 to V255 for the entire grayscale by using the reference voltage VREG provided from the reference voltage generator 500 and the gamma voltages V1, V19, V43, V87, V171, and V255 selected by a plurality of selectors 421 to 426.

FIG. 4 is a block diagram of a first reference voltage generator according to an exemplary embodiment.

Referring to FIG. 4, the first reference voltage generator 500-1 may include a voltage difference generator 510, a voltage difference selection unit 520, and a reference voltage output unit 530.

The voltage difference generator 510 includes a plurality of resistors coupled in series between the reference voltage VREF and a ground, and a voltage difference between the reference voltage VREF and the ground voltage is divided to a plurality of resistors to generate a plurality of distribution voltages. At this time, among a plurality of distribution voltages generated from the voltage difference generator 510, the distribution voltage corresponding to the voltage difference between the ELVDD voltage and the first gamma voltage V0 is selected by the voltage difference selection unit 520.

For example, when the driving transistor M2 of the pixel is the p-channel field effect transistor, the voltage difference between the first gamma voltage V0 light-emitting the organic light emitting diode (OLED) with the lowest grayscale and the ELVDD voltage may be about 0.2 V to 0.6 V.

At this time, the voltage difference generator 510 generates a plurality of distribution voltages included in a range from 0.2 V to 0.6 V. Also, a plurality of resistors included in the voltage difference generator 510 generate a plurality of distribution voltages as a predetermined unit such that the voltage difference between the first gamma voltage V0 and the ELVDD voltage may be minutely controlled. For this, the number of the plurality of resistors forming the voltage difference generator 510 and each resistance of the plurality of resistors are controlled. For example, a plurality of resistors may be constituted for a plurality of distribution voltages to be distributed as 6.25 mV units.

The voltage difference selection unit 520 selects the voltage corresponding to the voltage difference ΔV between the first power source voltage ELVDD′ and the reference voltage VREG′ from a plurality of distribution voltages in the process of predetermining the gamma voltage. The voltage difference selection unit 520 registers the voltage difference ΔV between the first power source voltage ELVDD′ and the reference voltage VREG′ in the process of predetermining the gamma voltage and outputs the registered voltage difference ΔV after the product production.

The reference voltage output unit 530 outputs a differential value of the voltage difference ΔV along with the second power source voltage ELVDD as the reference voltage VREG. The reference voltage output unit 530 includes a differential amplifier 531.

The first input terminal (+) of the differential amplifier 531 is input with the first voltage Va formed between the second resistor R2 and the fourth resistor R4 by the second power source voltage ELVDD, and the second input terminal (−) is input with the second voltage Vb formed between the first resistor R1 and the third resistor R3 by the voltage difference ΔV. The differential amplifier 531 outputs the differential value Vo between the first voltage Va and the second voltage Vb.

At this time, the resistances of all resistors R1 to R4 are the same. If the resistances of all resistors R1 to R4 are the same, the reference voltage VREG output from the differential amplifier 531 becomes VREG=ELVDD−ΔV.

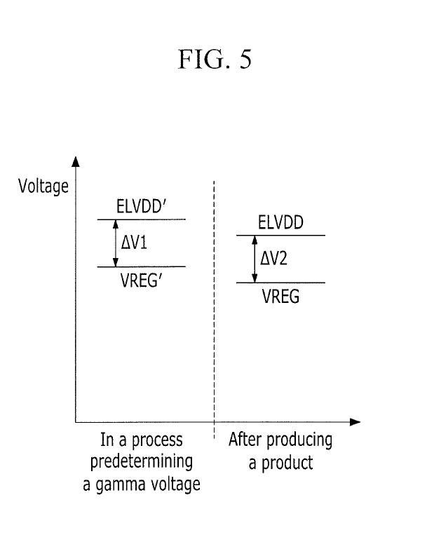

Although the first power source voltage ELVDD′ supplied in the process of predetermining the gamma voltage and the second power source voltage ELVDD supplied after producing the product are different, the first reference voltage generator 500-1 may output the reference voltage for the voltage difference ΔV between the power source voltage and the reference voltage in the process of predetermining the gamma voltage and after producing the product to be equally determined. This will be described with reference to FIG. 5.

FIG. 5 is an exemplary view showing a relation between an ELVDD voltage and a reference voltage in a process of predetermining a gamma voltage according to an exemplary embodiment and after producing a product.

Referring to FIG. 5, in the process of predetermining the gamma voltage, the ELVDD′ voltage is supplied to the display panel through the DC/DC converter of the test apparatus. The reference voltage is determined as VREG′ through the process of predetermining the gamma voltage and the voltage difference between the ELVDD′ voltage and the reference voltage VREG′ becomes ΔV1. The voltage difference ΔV1 between the ELVDD′ voltage and the reference voltage VREG′ is registered to the first reference voltage generator 500-1.

After producing the display device, the ELVDD voltage is supplied to the display panel through the DC/DC converter of the display device. For the ELVDD voltage supplied after producing the product according to the output deviation between the DC/DC converter of the display device and the DC/DC converter of the test apparatus, and the resistance of the connector, the resistance deviation is generated along with the ELVDD′ voltage supplied in the process of predetermining the gamma voltage (ELVDD≠ELVDD′).

The first reference voltage generator 500-1 receives the ELVDD voltage after the producing the display device. The voltage difference selection unit 520 outputs the voltage difference ΔV1 registered in the process of predetermining the gamma voltage. The reference voltage output unit 530 outputs the differential value between the ELVDD voltage and the voltage difference ΔV1 as the reference voltage VREG.

Accordingly, the voltage difference ΔV2 between the ELVDD voltage and the reference voltage VREG after the production of the display device becomes the same as the voltage difference ΔV1 between the ELVDD′ voltage and the reference voltage VREG′ in the process of predetermining the gamma voltage (ΔV1=ΔV2).

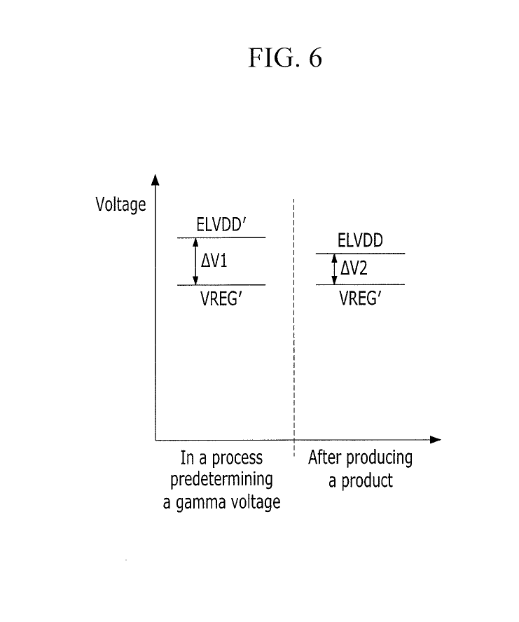

If the reference voltage provided to the gamma voltage generator 400 does not coincide with the ELVDD voltage and is provided as the voltage that is predetermined in the process of predetermining the gamma voltage, the voltage difference between the ELVDD voltage and the reference voltage after the product production may be different from that in the process of predetermining the gamma voltage. In this case, the luminance after the product production is not maintained as the luminance in the process of predetermining the gamma voltage and the image quality characteristic of the display device may be deteriorated. This will be described with reference to FIG. 6.

FIG. 6 is an exemplary view showing a relation between an ELVDD voltage and a reference voltage of a gamma voltage in a process of predetermining a gamma voltage in a conventional process of predetermining a gamma voltage and after producing a product.

Referring to FIG. 6, the ELVDD′ voltage is supplied to the display panel through the DC/DC converter of the test apparatus in the process of predetermining the gamma voltage. The reference voltage is determined as VREG′ through the process of predetermining the gamma voltage, and the voltage difference between the ELVDD′ voltage and the reference voltage VREG′ becomes ΔV1.

The ELVDD voltage is supplied to the display panel through the DC/DC converter provided in the display device after the product production of the display device (ELVDD≠ELVDD′). When also using the reference voltage VREG′ that is predetermined in the process of predetermining the gamma voltage after the product production of the display device, the voltage difference ΔV2 between the ELVDD voltage and the reference voltage VREG′ after the product production of the display device is different from the voltage difference ΔV1 between the ELVDD′ voltage and the reference voltage VREG′ in the process of predetermining the gamma voltage (ΔV1≠ΔV2). Accordingly, the luminance after the product production may be different from the luminance in the process of predetermining the gamma voltage such that the image quality characteristic of the display device may be deteriorated.

FIG. 7 is a block diagram of a second reference voltage generator according to an exemplary embodiment.

Referring to FIG. 7, the second reference voltage generator 500-2 includes the first differential amplifier 540, a voltage difference generator 550, a voltage difference selection unit 560, and a base voltage output unit 570.

The reference voltage VREF is input to the first input terminal (+) of the first differential amplifier 540, and the distribution voltage selected from the voltage difference selection unit 560 is input to the second input terminal (−). The first differential amplifier 540 outputs the amplifying voltage ΔVg corresponding to the voltage difference between the base voltage VGS and the ELVDD voltage to the output terminal according to the voltage input to the first input terminal (+) and the second input terminal (−). The base voltage VGS is a voltage used to generate a plurality of gamma voltages in the gamma voltage generator 400.

The voltage difference generator 550 includes a plurality of resistors coupled in series between the amplifying voltage ΔVg of the first differential amplifier 540 and the ground and divides the voltage difference between the amplifying voltage ΔVg of the first differential amplifier 540 and the ground to a plurality of resistors to generate a plurality of distribution voltages.

The voltage difference selection unit 560 selects the distribution voltage to output the amplifying voltage ΔVg corresponding to the voltage difference between the base voltage VGS and the ELVDD voltage through the first differential amplifier 540. When a position corresponding to the distribution voltage selected from the voltage difference generator 550 is referred to as P, a resistance sum of the resistances between the position P and the ground is referred to as Ra, and a resistance sum of the resistances between the position P and the output terminal of the first differential amplifier 540 is referred to as Rb. At this time, the amplifying voltage ΔVg=VREF*(1+Rb/Ra) is output from the first differential amplifier 540.

For example, the voltage difference between the base voltage VGS and the ELVDD voltage used to generate a plurality of gamma voltages for a plurality of grayscales by the gamma voltage generator 400 may be in a range from about 3.6 V to 4.6 V. When the reference voltage VREF is referred to as 2 V, the plurality of resistors included in the voltage difference generator 550 may be constituted for the range of Rb/Ra to be 0.8 to 1.3. Also, the plurality of resistors included in the voltage difference generator 550 may be constituted for the amplifying voltage ΔVg to be minutely controlled and output as a unit of 100 mV.

The voltage difference selection unit 560 selects the distribution voltage such that the amplifying voltage ΔVg corresponding to the voltage difference of the first power source voltage ELVDD′ and the base voltage VGS′ in the process of predetermining the gamma voltage is output from the first differential amplifier 540. Also, the voltage difference selection unit 560 registers the amplifying voltage ΔVg corresponding to the voltage difference of the first power source voltage ELVDD′ and the base voltage VGS′ in the process of predetermining the gamma voltage, and outputs the registered amplifying voltage ΔVg through the first differential amplifier 540.

The base voltage output unit 570 outputs the differential value of the second power source voltage ELVDD and the amplifying voltage ΔVg as the base voltage VGS. The base voltage output unit 570 includes the second differential amplifier 571.

The first input terminal (+) of the second differential amplifier 571 is input with the first voltage Va formed between the second resistor R12 and the fourth resistor R14 by the second power source voltage ELVDD, and the second input terminal (−) is input with the second voltage Vb formed between the first resistor R11 and the third resistor R13 by the amplifying voltage ΔVg. The second differential amplifier 571 outputs the differential value Vo of the first voltage Va and the second voltage Vb.

At this time, the resistances of all resistors R11 to R14 may be the same. If the resistances of all resistors R11 to R14 are the same, the base voltage VGS output from the second differential amplifier 571 becomes VGS=ELVDD−ΔVg.

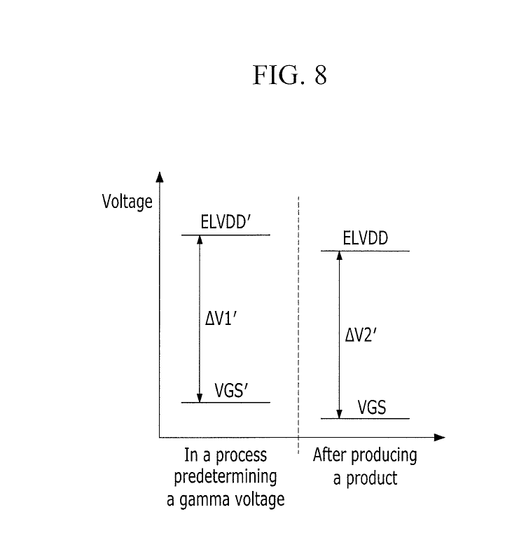

Although the first power source voltage ELVDD′ is supplied in the process of predetermining the gamma voltage and the second power source voltage ELVDD is supplied after producing the product, the second reference voltage generator 500-2 outputs the base voltage such that the voltage difference ΔV′ between the power source voltage and the base voltage in the process of predetermining the gamma voltage and after producing the product is the same. This will be described with reference to FIG. 8.

FIG. 8 is an exemplary view showing a relation between an ELVDD voltage and a base voltage in a process of predetermining a gamma voltage and after producing a product according to an exemplary embodiment.

Referring to FIG. 8, in the process of predetermining the gamma voltage, the ELVDD′ voltage is supplied to the display panel through the DC/DC converter of the test apparatus. The base voltage is determined as VGS′ through the process of predetermining the gamma voltage, and the voltage difference between the ELVDD′ voltage and the base voltage VGS′ becomes ΔV1′. The voltage difference ΔV1′ between the ELVDD′ voltage and the base voltage VGS′ is registered to the second reference voltage generator 500-2.

After producing the display device, the ELVDD voltage is supplied to the display panel through the DC/DC converter of the display device. For the ELVDD voltage supplied after producing the product according to the output deviation between the DC/DC converter of the display device and the DC/DC converter of the test apparatus, and the resistance of the connector, the resistance deviation is generated along with the ELVDD′ voltage supplied in the process of predetermining the gamma voltage (ELVDD≠ELVDD′).

The second reference voltage generator 500-2 receives the ELVDD voltage after producing the display device. The voltage difference selection unit 560 outputs the amplifying voltage ΔVg registered in the process of predetermining the gamma voltage through the first differential amplifier 540. The reference voltage output unit 570 outputs the differential value between the ELVDD voltage and the amplifying voltage ΔVg as the base voltage VGS.

Accordingly, the voltage difference ΔV2′ between the ELVDD voltage and the base voltage VGS after the production of the display device becomes the same as the voltage difference ΔV1 between the ELVDD′ voltage and the base voltage VGS′ in the process of predetermining the gamma voltage (ΔV1′=ΔV2′).

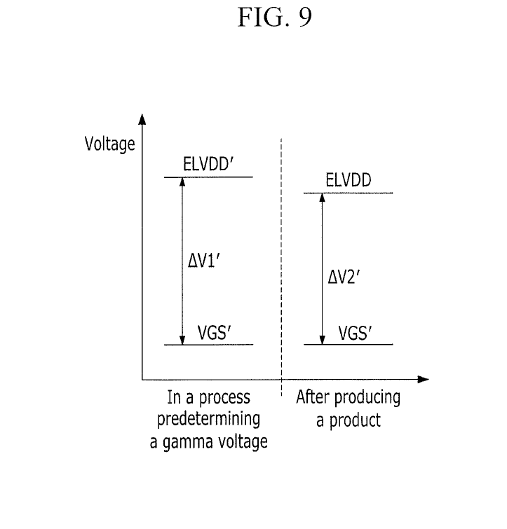

If the base voltage provided to the gamma voltage generator 400 does not coincide with the ELVDD voltage and is provided as the voltage that is predetermined in the process of predetermining the gamma voltage, the voltage difference between the ELVDD voltage and the base voltage after the product production may be different from that in the process of predetermining the gamma voltage. In this case, the luminance after the product production is not maintained as the luminance in the process of predetermining the gamma voltage, and the image quality characteristic of the display device may be deteriorated. This will be described with reference to FIG. 9.

FIG. 9 is an exemplary view showing a relation between an ELVDD voltage and a base voltage of a gamma voltage in a conventional process of predetermining a gamma voltage and after producing a product.

Referring to FIG. 9, the ELVDD′ voltage is supplied to the display panel through the DC/DC converter of the test apparatus in the process of predetermining the gamma voltage. The base voltage is determined as VGS′ through the process of predetermining the gamma voltage, and the voltage difference between the ELVDD′ voltage and the base voltage VGS′ becomes ΔV1′.

The ELVDD voltage is supplied to the display panel through the DC/DC converter provided in the display device after the product production of the display device (ELVDD≠ELVDD′). When also using the base voltage VGS′ that is predetermined in the process of predetermining the gamma voltage after the product production of the display device, the voltage difference ΔV2′ between the ELVDD voltage and the base voltage VGS′ after the product production of the display device is different from the voltage difference ΔV1′ between the ELVDD′ voltage and the base voltage VGS′ in the process of predetermining the gamma voltage (ΔV1′≠ΔV2′). Accordingly, the luminance after the product production may be different from the luminance in the process of predetermining the gamma voltage such that the image quality characteristic of the display device may be deteriorated.

However, according to the description above, the voltage difference between the ELVDD voltage and the reference voltage and the voltage difference between the ELVDD voltage and the base voltage in the process of predetermining the gamma voltage coincides with the reference voltage and the base voltage to the ELVDD voltage after the product production such that the deterioration of the image quality characteristic of the display device may be solved.

The drawings referred to hereinabove and the detailed description are presented for illustrative purposes only, and are not intended to define meanings or limit the scope of the example embodiments as set forth in the following claims. Those skilled in the art will understand that various modifications and equivalent embodiments are possible. Consequently, the true technical protective scope of the example embodiments must be determined based on the technical spirit of the appended claims.

<Description of Symbols>

| | |
|---|---|
| 100: signal controller | 200: scan driver |
| 300: data driver | 400: gamma voltage generator |
| 410: reference voltage division unit | 420: gamma voltage selection unit |
| 430: gamma voltage output unit | 440: micro-controller |
| 500: reference voltage generator | 500-1: first reference voltage generator |
| 500-2: second reference voltage | 510: voltage difference generator |
| generator | |
| 520: voltage difference selection unit | 530: reference voltage output unit |
| 540: first differential amplifier | 550: voltage difference generator |
| 560: voltage difference selection unit | 570: base voltage output unit |

What is claimed is:

1. A display device, comprising:
a display unit including a plurality of pixels connected to a plurality of data lines;
a data driver selecting a grayscale voltage according to an image data signal among a plurality of gamma voltages to apply the grayscale voltage to the plurality of data lines;
a gamma voltage generator generating a plurality of gamma voltages; and
a first reference voltage generator generating a reference voltage to generate a plurality of gamma voltages in cooperation with a power source voltage to drive the plurality of pixels.

2. The display device of claim 1, wherein the first reference voltage generator registers a voltage difference between a first power source voltage and a first reference voltage in the process of predetermining the gamma voltage, and generates a second reference voltage as a differential value between a second power source voltage and the registered voltage difference.

3. The display device of claim 2, wherein the first reference voltage generator includes:
a voltage difference generator including a plurality of resistors coupled in series between a reference voltage and a ground voltage;
a voltage difference selection unit selecting and outputting a voltage corresponding to a voltage difference between the first power source voltage and the first reference voltage among a plurality of distribution voltages distributed to a plurality of resistors; and
a reference voltage output unit outputting a differential value between the second power source voltage and the voltage output from the voltage difference selection unit as the second reference voltage.

4. The display device of claim 3, wherein a plurality of resistors included in the voltage difference generator have a resistance determined for a plurality of distribution voltages to be distributed as a predetermined unit.

5. The display device of claim 3, wherein the voltage difference selection unit registers a voltage difference between the first power source voltage and the first reference voltage in the process of predetermining the gamma voltage, and outputs the registered voltage difference to the reference voltage output unit after producing a product.

6. The display device of claim 3, wherein the reference voltage output unit includes a differential amplifier outputting a differential value between a power source voltage supplied from the outside and the voltage output from the voltage difference selection unit.

7. The display device of claim 1, wherein the gamma voltage generator includes:
a reference voltage division unit including a plurality of resistors coupled in series between the reference voltage and the base voltage;
a gamma voltage selection unit selecting a plurality of gamma voltages corresponding to a predetermined grayscale by using a plurality of distribution voltages distributed to a plurality of resistors; and
a gamma voltage output unit outputting a plurality of gamma voltages corresponding to an entire grayscale by using the reference voltage provided from the reference voltage generator and a plurality of gamma voltages selected from the gamma voltage selection unit.

8. The display device of claim 7, wherein the gamma voltage selection unit includes a first selector selecting a second gamma voltage representing a gray level higher than the first gamma voltage corresponding to the reference voltage by one.

9. The display device of claim 8, wherein the gamma voltage selection unit further includes a second selector selecting a seventh gamma voltage as a lowest voltage among a plurality of gamma voltages corresponding to the entire grayscale.

10. The display device of claim 9, wherein the gamma voltage selection unit further includes a sixth selector selecting a sixth gamma voltage by using a distribution resistor connected to the second gamma voltage transmitted from the first selector and the seventh gamma voltage selected from the second selector.

11. The display device of claim 10, wherein the gamma voltage selection unit further includes a fifth selector selecting a fifth gamma voltage by using a distribution resistor connected to the second gamma voltage transmitted from the first selector and the sixth gamma voltage selected from the six selector.

12. The display device of claim 11, wherein the gamma voltage selection unit further includes a fourth selector selecting a fourth gamma voltage by using a distribution resistor connected to the second gamma voltage transmitted from the first selector and the fifth gamma voltage selected from the fifth selector.

13. The display device of claim 12, wherein the gamma voltage selection unit further includes a third selector selecting a third gamma voltage by using a distribution resistor connected to the second gamma voltage transmitted from the first selector and the fourth gamma voltage selected from the fourth selector.

14. The display device of claim 7, wherein the gamma voltage generator further includes a micro-controller providing a register value for minute control of the gamma voltage to the gamma voltage selection unit.

15. The display device of claim 1, further comprising a second reference voltage generator generating a base voltage to generate a plurality of gamma voltages in cooperation with a power source voltage to drive a plurality of pixels.

16. The display device of claim 15, wherein the second reference voltage generator registers a voltage difference between a first power source voltage and a first base voltage in the process of predetermining the gamma voltage, and generates a second base voltage as a differential value between a second power source voltage and the registered voltage difference.

17. The display device of claim 16, wherein the second reference voltage generator includes:
a first differential amplifier including a first input terminal input with the reference voltage and an output terminal outputting the amplifying voltage;
a voltage difference generator including a plurality of resistors coupled in series between the amplifying voltage and a ground;
a voltage difference selection unit selecting a distribution voltage from the voltage difference generator to output an amplifying voltage corresponding to a voltage difference between the first power source voltage and the first base voltage from the first differential amplifier and to input the distribution voltage to the second input terminal of the first differential amplifier; and
a base voltage output unit outputting a differential value of the second power source voltage and the amplifying voltage as a second base voltage.

18. The display device of claim 17, wherein the voltage difference selection unit registers the amplifying voltage corresponding to the voltage difference between the first power source voltage and the first base voltage in a process of generating the gamma voltage, and the registered amplifying voltage is output through the first differential amplifier after producing the product.

19. The display device of claim 17, wherein the base voltage output unit includes a second differential amplifier that outputs a differential value of a power source voltage supplied from the outside and an amplifying voltage output from the first differential amplifier.

20. A gamma voltage generating apparatus, comprising:
a reference voltage generator registering a voltage difference between a first power source voltage to drive a plurality of pixels and a predetermined first reference voltage in a process of predetermining a gamma voltage, and generating a second reference voltage as a differential value between a second power source voltage to drive a plurality of pixels and the registered voltage difference; and
a gamma voltage generator generating a plurality of gamma voltages by using the second reference voltage.

21. The gamma voltage generating apparatus of claim 20, wherein the first reference voltage generator includes:
a voltage difference generator including a plurality of resistors coupled in series between a reference voltage and a ground voltage;
a voltage difference selection unit selecting and outputting a voltage corresponding to a voltage difference between the first power source voltage and the first reference voltage among a plurality of distribution voltages distributed to a plurality of resistors; and
a reference voltage output unit outputting a differential value between the second power source voltage and the voltage output from the voltage difference selection unit as the second reference voltage.

22. The gamma voltage generating apparatus of claim 21, wherein a plurality of resistors included in the voltage difference generator have resistances determined for a plurality of distribution voltages to be distributed as a predetermined unit.

23. The gamma voltage generating apparatus of claim 21, wherein the voltage difference selection unit registers a voltage difference between the first power source voltage and the first reference voltage in the process of predetermining the gamma voltage, and outputs the registered voltage difference to the reference voltage output unit after producing a product.

24. The gamma voltage generating apparatus of claim 21, wherein the reference voltage output unit includes a differential amplifier outputting a differential value between the second power source voltage and the voltage output from the voltage difference selection unit.

25. The gamma voltage generating apparatus of claim 20, wherein the gamma voltage generator includes:
a reference voltage division unit including a plurality of resistors coupled in series between the second reference voltage and the ground voltage;
a gamma voltage selection unit selecting a plurality of gamma voltages corresponding to a predetermined grayscale by using a plurality of distribution voltages distributed to a plurality of resistors; and
a gamma voltage output unit outputting a plurality of gamma voltages corresponding to an entire grayscale by using the second reference voltage and a plurality of gamma voltages selected from the gamma voltage selection unit.

26. The gamma voltage generating apparatus of claim 25, wherein the gamma voltage selection unit includes a first selector selecting the second gamma voltage representing a gray level higher than the first gamma voltage corresponding to the second reference voltage by one.

27. The gamma voltage generating apparatus of claim 26, wherein the gamma voltage selection unit further includes a second selector selecting a seventh gamma voltage as a lowest voltage among a plurality of gamma voltages corresponding to the entire grayscale.

28. The gamma voltage generating apparatus of claim 27, wherein the gamma voltage selection unit further includes a sixth selector selecting a sixth gamma voltage by using a distribution resistor connected to the second gamma voltage transmitted from the first selector and the seventh gamma voltage selected from the second selector.

29. The gamma voltage generating apparatus of claim 28, wherein the gamma voltage selection unit further includes a fifth selector selecting a fifth gamma voltage by using a distribution resistor connected to the second gamma voltage transmitted from the first selector and the sixth gamma voltage selected from the six selector.

30. The gamma voltage generating apparatus of claim 29, wherein the gamma voltage selection unit further includes a fourth selector selecting a fourth gamma voltage by using a distribution resistor connected to the second gamma voltage transmitted from the first selector and the fifth gamma voltage selected from the fifth selector.

31. The gamma voltage generating apparatus of claim 30, wherein the gamma voltage selection unit further includes a third selector selecting a third gamma voltage by using a distribution resistor connected to the second gamma voltage transmitted from the first selector and the fourth gamma voltage selected from the fourth selector.

32. The gamma voltage generating apparatus of claim 20, further comprising a second reference voltage generator generating a base voltage to generate a plurality of gamma voltages in cooperation with a power source voltage to drive a plurality of pixels.

33. The gamma voltage generating apparatus of claim 32, wherein the second reference voltage generator registers a voltage difference between a first power source voltage and a first base voltage in the process of predetermining the gamma voltage, and generates a second base voltage as a differential value between a second power source voltage and the registered voltage difference.

34. The gamma voltage generating apparatus of claim 33, wherein the second reference voltage generator includes:
a first differential amplifier including a first input terminal input with the reference voltage and an output terminal outputting the amplifying voltage;
a voltage difference generator including a plurality of resistors coupled in series between the amplifying voltage and a ground;
a voltage difference selection unit selecting a distribution voltage from the voltage difference generator to output an amplifying voltage corresponding to a voltage difference between the first power source voltage and the first base voltage from the first differential amplifier and to input the distribution voltage to the second input terminal of the first differential amplifier; and
a base voltage output unit outputting a differential value of the second power source voltage and the amplifying voltage as a second base voltage.

35. The gamma voltage generating apparatus of claim 34, wherein the voltage difference selection unit registers the amplifying voltage corresponding to the voltage difference between the first power source voltage and the first base voltage in a process of generating the gamma voltage, and the registered amplifying voltage is output through the first differential amplifier after producing the product.

36. The gamma voltage generating apparatus of claim 34, wherein the base voltage output unit includes a second differential amplifier that outputs a differential value of a power source voltage supplied from the outside and an amplifying voltage output from the first differential amplifier.

37. A method of generating a gamma voltage, the method comprising:
registering a voltage difference between a first power source voltage to drive a plurality of pixels and a predetermined first reference voltage in the process of predetermining the gamma voltage;
generating a second reference voltage as a differential value between a second power source voltage to drive a plurality of pixels and the registered voltage difference after producing a product; and
generating a plurality of gamma voltages by using the second reference voltage.

38. The method of claim 37, wherein registering the voltage difference includes selecting a voltage corresponding to a voltage difference between the first power source voltage and the first reference voltage among a plurality of distribution voltage distributed to a plurality of resistors coupled in series between the reference voltage and the ground voltage.

39. The method of claim 37, further comprising registering a second voltage difference of the first power source voltage to drive a plurality of pixels and a predetermined first base voltage in the process of predetermining the gamma voltage.

40. The method of claim 39, further comprising generating a second base voltage as a differential value of the second power source voltage to drive a plurality of pixels and the registered second voltage difference after producing a product.

41. The method of claim 40, wherein generating a plurality of gamma voltages includes generating a plurality of gamma voltages by using the second reference voltage and the second base voltage.

42. The method of claim 37, wherein generating a plurality of gamma voltages includes:
selecting a plurality of gamma voltages corresponding to a predetermined grayscale by using a plurality of distribution voltages distributed to a plurality of resistors coupled in series between the second reference voltage and the ground voltage; and
generating a plurality of gamma voltages corresponding to an entire grayscale by using the second reference voltage and a plurality of gamma voltages corresponding to the predetermined grayscale.

43. The method of claim 42, wherein selecting a plurality of gamma voltages corresponding to a predetermined grayscale includes selecting the second gamma voltage representing a gray level higher than the first gamma voltage corresponding to the second reference voltage.

44. The method of claim 43, wherein selecting a plurality of gamma voltages corresponding to a predetermined grayscale includes selecting a seventh gamma voltage as a lowest voltage among a plurality of gamma voltages corresponding to the entire grayscale

45. The method of claim 44, wherein selecting a plurality of gamma voltages corresponding to a predetermined grayscale includes selecting a sixth gamma voltage by using a distribution resistor connected to the second gamma voltage and the seventh gamma voltage.

46. The method of claim 45, wherein selecting a plurality of gamma voltages corresponding to a predetermined grayscale includes selecting a fifth gamma voltage by using a distribution resistor connected between the second gamma voltage and the sixth gamma voltage.

47. The method of claim 46, wherein selecting a plurality of gamma voltages corresponding to a predetermined grayscale includes selecting a fourth gamma voltage by using a distribution resistor connected between the second gamma voltage and the fifth gamma voltage.

48. The method of claim 47, wherein selecting a plurality of gamma voltages corresponding to a predetermined grayscale includes selecting a third gamma voltage by using a distribution resistor connected between the second gamma voltage and the fourth gamma voltage.
